(19) United States
(12) Patent Application Publication
(10) Pub. No.: US 2008/0317647 A1
(43) Pub. Date: Dec. 25, 2008

(54) Autoclaves with Combined Air Flow

(76) Inventor: Tari Taricco, Rancho Palos Verdes, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/628,104

(22) PCT Filed: May 27, 2005
(86) PCT No.: PCT/US05/18889

§ 371 Date: Sep. 24, 2007

Related U.S. Application Data
(60) Provisional application No. 60/575,532, filed on May 28, 2004.

(51) Int. Cl. B01J 3/04

(52) U.S. Cl. 422/295; 422/242

(57) ABSTRACT

Autoclaves with combined airflow to provide controllable heating or cooling of parts being processed are disclosed. Gas flow along the autoclave is provided in one or more duct areas (48,52), with a plurality of duct valves (50) along the duct (48,52) controllably diverting the gas into the working area of the autoclave. In a fully configured autoclave, duct valves (50) divert gas flowing from the fan or blower (38) from the ceiling, sides and floor of an autoclave to provide a controllable, three dimensional, air flow in the working area of the autoclave. Control of the duct valves (50) may be manual or automatic, with individual or ganged duct valve control. Computer control based on temperature sensor on parts in the working area of the autoclave may be used to provide uniform heating or cooling, or intentional non-uniform heating or cooling rates. Various embodiments are disclosed.

### BACKGROUND OF THE INVENTION

1. Field of the Invention

The present invention relates to the field of autoclaves.

2. Prior Art

Autoclaves are well known in the prior art. Such devices are typically used for a variety of purposes ranging from experimental to routine and production processing where the item being processed must be subjected to elevated or depressed temperatures, elevated or depressed pressures, special gas or humidity environments or any combination of such conditions. Axial and longitudinal cross sectional views of a typical conventional autoclave may be seen in FIGS. 1 and 2. Such autoclaves are generally in the configuration of a pressure vessel having a cylindrical shell 20, a closed end 22 and an openable end 24 which may be locked and sealed with respect to the cylindrical shell 20 by the engagement of a lock/seal, the design of which locks and seals are well known. The cylindrical section 20 typically has a roof or ceiling 28 and a floor 30 defining a working space 32 and ducts 34 and 36, respectively. At the closed end of the cylindrical section 20 is typically a motor 38 and fan or blower 40 for causing air circulation through the ducts 36 and then back through the working region 32 of the autoclave. In the embodiment shown, the motor 38 is within its own enclosure 42 which may or may not be sealed with respect to the autoclave, though in other forms the motor may actually be within the autoclave, or as a further alternative, totally outside the autoclave with the shaft supporting the fan or blower having a rotating seal with respect to the end 22 of the autoclave. These features, as well as manner or heating and/or cooling the autoclave, pressurizing or providing a vacuum thereto, etc., can vary substantially and are all well known in the prior art.

It will be noted from FIGS. 1 and 2 that the gas flow path within the autoclave is substantially well defined, predetermined, and substantially axial, except at the ends thereof. In general in such autoclaves, the heaters or coolers will not be in the working area of the autoclave but rather will be, by way of example, in the region of the fan or blower or above the roof panel and below the floor panel. Because of the axial flow through the working area of the autoclave, heating or cooling within the autoclave of FIG. 2 will be greatest at the left end of the autoclave, diminishing along the autoclave to be a minimum at the right end of the autoclave because of the transfer of heat to or from objects being processed in the autoclave along that flow path. Accordingly, certain parts in the working area will reach the desired temperature first, and thus, be processed longer than the other parts to assure that all parts have been subjected to the desired temperature for an adequate length of time. This is wasteful of processing time and heating or cooling energy, and provides non-uniform processing of parts within the autoclave which can have detrimental effects on the parts.

### BRIEF DESCRIPTION OF THE DRAWINGS

FIGS. 1 and 2 are axial and longitudinal cross sections, respectively, of a typical prior art autoclave.

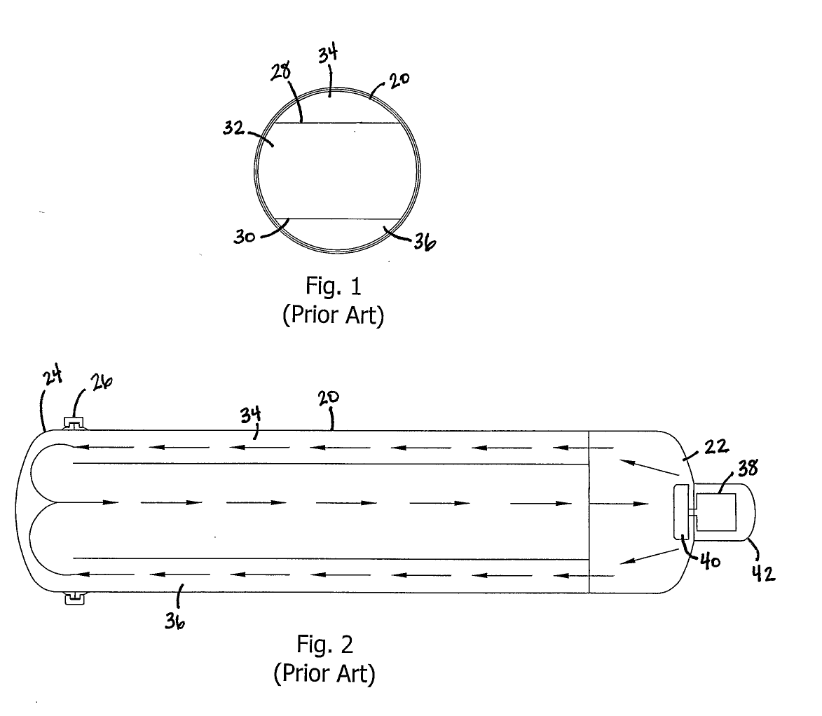

FIGS. 3 and 4 are axial and longitudinal cross sections, respectively, of one embodiment of autoclave of the present invention.

FIGS. 5 and 6 are axial and longitudinal cross sections, respectively, of another embodiment of autoclave of the present invention.

FIGS. 7 and 8 are axial and longitudinal cross sections, respectively, of still another embodiment of autoclave of the present invention.

FIG. 9 is a cross section of part of an autoclave in accordance with an embodiment of the present invention.

### DETAILED DESCRIPTION OF THE PREFERRED EMBODIMENTS

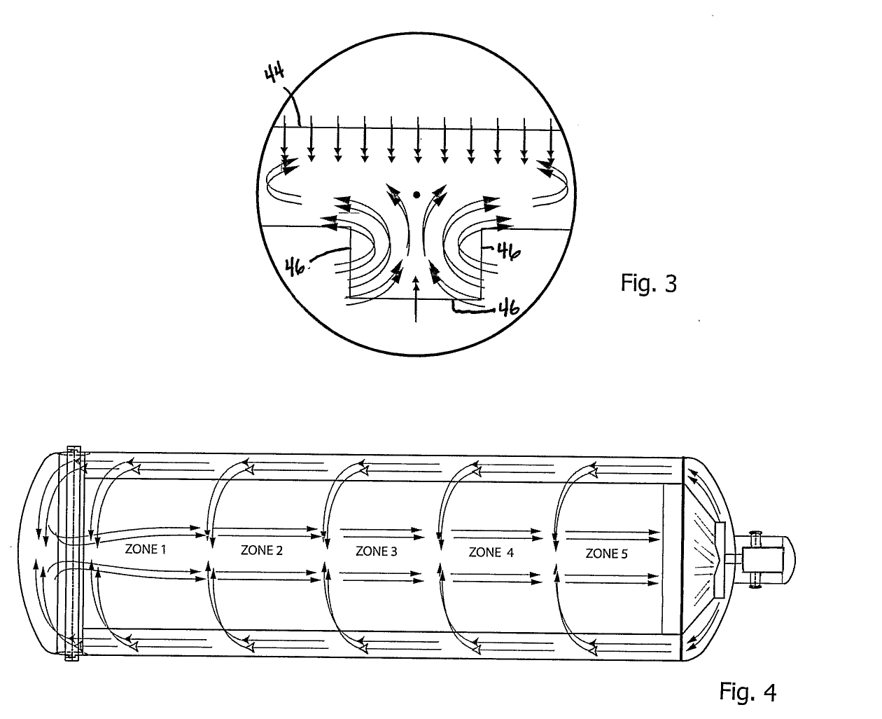

FIGS. 3 and 4 are cross-sections taken perpendicular to the longitudinal axis and along the cross-axis, respectively, of an exemplary autoclave incorporating the present invention. As may be seen in FIG. 3, a typical autoclave incorporating the present invention will have a ceiling or roof 44, and some form of floor, or equivalent structure 46, for receiving parts or work pieces that the user puts into the autoclave to perform a pressure/temperature batch process cycle on. In accordance with the present invention, the ceiling 44 and floor structure, or equivalent 46, are vented, preferably in a controllable manner. This allows the fan shown in FIG. 4 to direct heated or cooled air within the autoclave over the ceiling 42 and under the floor or corresponding structure 44, with controlled amounts of the heated air being directed into the various zones along the longitudinal axis of the autoclave pressure vessel, with the remainder of the air being directed longitudinally back toward the fan from the autoclave door region.

In this way, heating (or cooling) rates in the various zones may be equalized, as desired. Alternatively, if the tool or work piece has a variation in heat capacity along the axis of the autoclave, the heating or cooling rates in the various zones may be intentionally made unequal to cause equal temperatures and equal rates of temperature change in the work piece along its axes. In any event, by way of example, the invention has the advantage of higher efficiency by not using energy to heat or cool parts to a higher or lower temperature than is needed to achieve the minimum time/temperature requirement for the lowest temperature region. The present invention also yields improved and more uniform results by allowing the control of heating rates and temperature profiles along the axes of the autoclave.

In a preferred embodiment, the vents are automatically controlled, though could be manually controlled if desired. Such control could be achieved by motors, solenoids, compressed air or other means as is well known in the art. Whether automatic or manual, the temperatures themselves may be monitored by way of thermocouples or by other means with automatic control, if used, being provided by a computer or some other form of control, preferably a processor-based control system operating under program control.

Thus, the “combined air flow” provides airflow in the working space of the autoclave from three dimensions (3D Flow):

1. from the top downward to the tool;

2. from the bottom upward under the tool; and,

3. from the front to the rear of the tool.

Additionally, the combined air flow provides the ability to have controlled longitudinal zones where the air flow and therefore heat transfer can be controlled, thus adjusting the heat flow to the part using part temperatures as measured by thermocouples or other means. In summary, older systems provided primarily axial or vertical flow only in 2 dimensions. The combined air flow of the present invention provides air flow in 3 dimensions, with the air flow being fully turbulent for better heat transfer. Zone control provides for adjustability of the flow to the part requirements dynamically during the batch process.

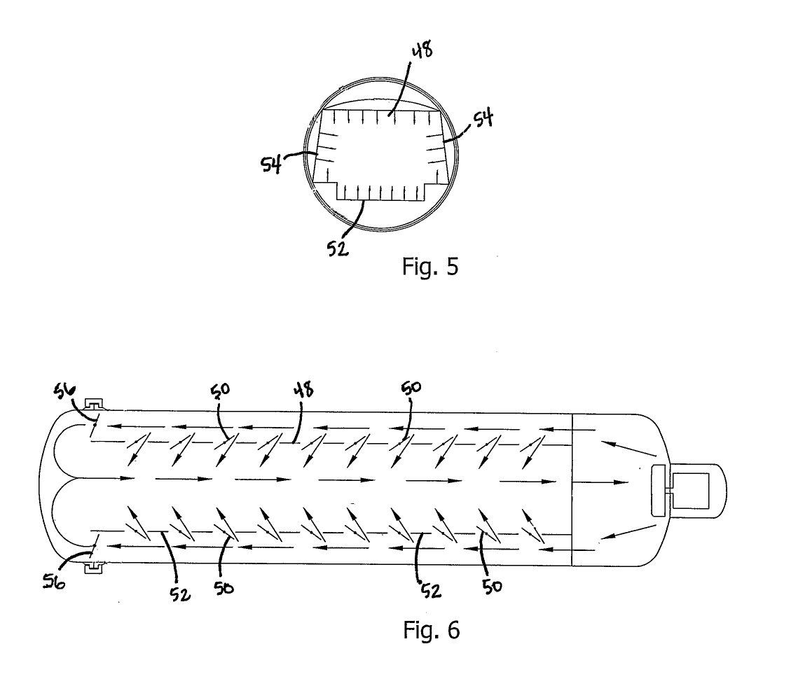

Now referring to FIGS. 5 and 6, schematic diagrams showing an axial cross-section and a longitudinal cross-section of an autoclave may be seen. These Figures illustrate one method of obtaining the combined airflow desired. In particular, in this embodiment, the ceiling 48 includes a plurality of duct valves 50, as does the floor 52. In practice, the valves may be set somewhat below the floor so as to not interfere with the flat surface for disposition of parts to be processed thereon. Also in this embodiment, as may be seen in FIG. 5, the sidewalls 54 are similarly provided with duct valves so that the flow from above, from below and from each side, as well as the axial flow, is fully adjustable. In that regard, the proportion of axial flow may be controlled in part by duct valves 56 of FIG. 6.

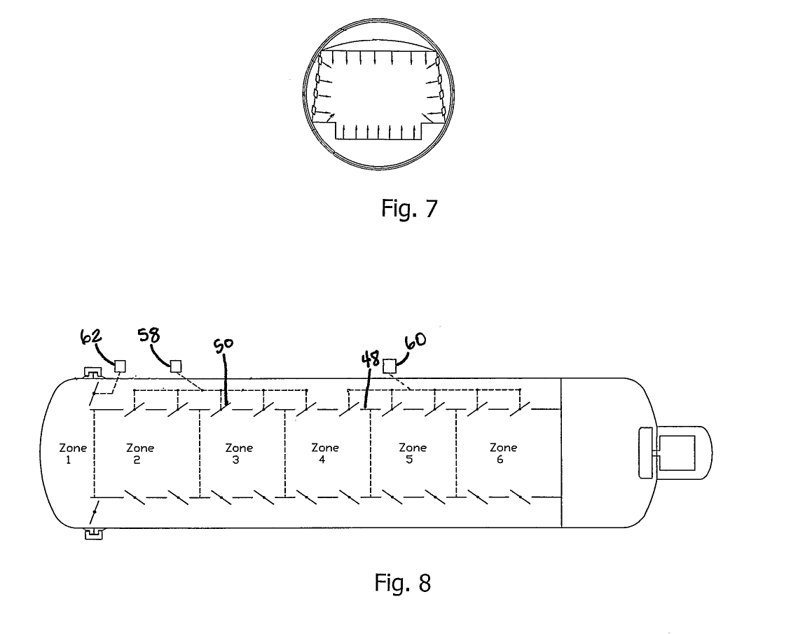

The duct valves of FIGS. 5 and 6 may be individually controllable, either manually or automatically, such as in a manner to be described. As an alternative to individual control of the duct valves, as suggested by the embodiment of FIGS. 5 and 6, FIGS. 7 and 8 show a similar embodiment where the duct valves 50 in the ceiling 48 are ganged in two groups, with separate valve actuators 58 and 60 actuating each group independently, as well as valve actuator 62 operating the axial flow duct valve in the ceiling. Obviously, the grouping and operation of a plurality of duct valves in unison may similarly be applied to the floor and sides of the autoclave.

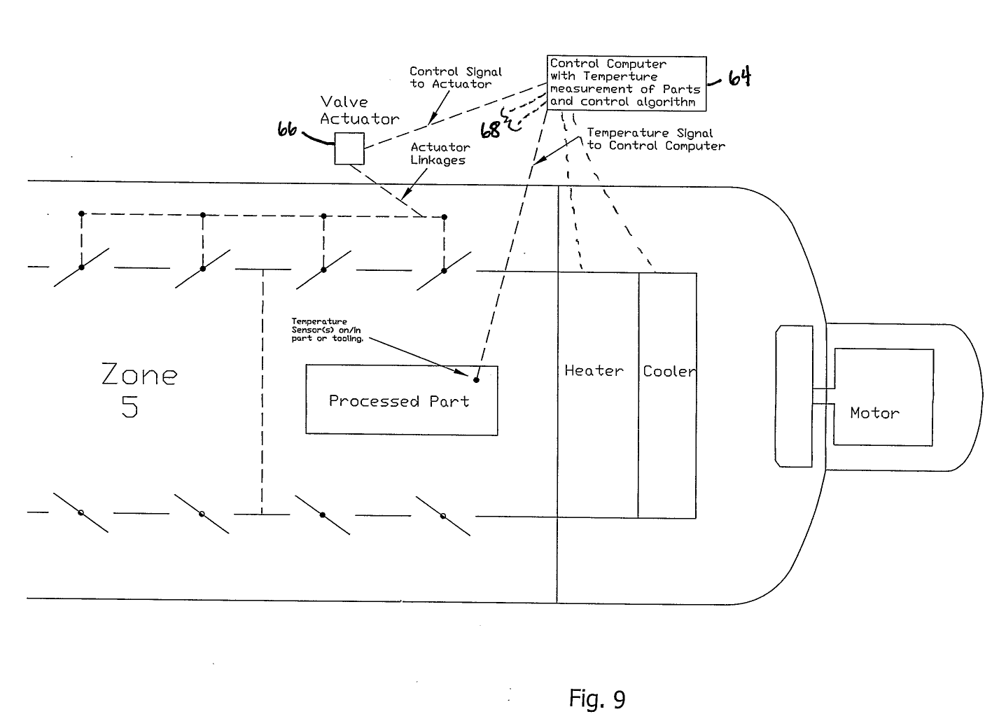

Now referring to FIG. 9, a cross-section of part of an autoclave incorporating computer control on the duct valves for even temperature distribution of the parts being processed may be seen. As shown in this Figure, a control computer 64 is coupled to control the Heater and/or the Cooler, as well as duct valve actuator 66, based on the measurement of temperature of the parts being processed, typically through thermocouples coupled to the parts at various positions along the autoclave. In that regard, the autoclave may be processing a single large part, in which case thermocouples would be placed at various positions along the length of the part. In other cases, the autoclave may be processing numerous relatively smaller parts, in which case thermocouples may be placed on selected parts along the autoclave. Accordingly as shown in FIG. 9, additional connections 68 are provided for coupling to additional thermocouples at other positions along the autoclave, as well as for controlling other valve actuators similar to actuator 66 for controlling the temperatures in those regions of the autoclave. The control computer 64, of course, operates under appropriate program control to provide uniform heating (or cooling) of the part or parts in the autoclave and to reduce the heating or cooling when the desired temperature is reached to maintain the desired temperature for the time set for the processing. In the embodiment shown in FIG. 9, four duct valves are ganged together, though of course any number of duct valves may be ganged together, or as previously indicated, independent control could be provided if desired. Also the embodiments shown herein are shown in a horizontal disposition with an end door, though other orientations such as a vertical orientation and other door configurations may be used as desired.

In the foregoing description of the computer control, the temperature sensors were described as being placed on the part or parts being processed. It should be noted that the sensors might actually be in the parts to monitor internal temperature, or in the autoclave in the vicinity of the parts. In other applications, the sensors may be sensing some other parameters such as moisture or gas composition, to name but two examples, in which case again the sensors may be on, in or in the vicinity of the part or parts. In cases where more than one environmental parameter is controlled, sensors of different types would be used, which could have substantially the same or different placement as desired.

While certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. An autoclave comprising:
an elongated autoclave shell having a first closed end and a second openable end;
at least one fan motor with fan attached coupled to the closed end;
a first panel within and spaced from a wall of the autoclave shell;
the first panel having a plurality of adjustable duct valves disposed along the first panel for controllably diverting gas flowing between the first panel and the wall of the autoclave shell to an opposite side of the panel.

2. The autoclave of claim 1 wherein the adjustable duct valves are independently controllable.

3. The autoclave of claim 1 wherein the adjustable duct valves are coupled together in groups, each group being controllable in unison.

4. The autoclave of claim 1 further comprising a second panel parallel to the first panel and also spaced from a wall of the autoclave shell.

5. The autoclave of claim 4 wherein the second panel also has a plurality of adjustable duct valves disposed along the second panel for controllably diverting gas flowing between the second panel and the wall of the autoclave shell to an opposite side of the panel.

6. The autoclave of claim 5 wherein the elongated autoclave shell is a horizontally disposed tubular shell, the first panel forms a roof within the autoclave and the second panel forms a floor of the autoclave.

7. The autoclave of claim 6 wherein the second panel is stepped downward between two sides thereof.

8. The autoclave of claim 6 further comprising first and second oppositely disposed side panels, each having a plurality of adjustable duct valves disposed along the respective side panel for controllably diverting gas flowing between the respective side panel and an adjacent wall of the autoclave shell to an opposite side of the side panel.

9. The autoclave of claim 8 wherein the second panel is stepped downward between two sides thereof.

10. The autoclave of claim 8 wherein the fan is configured to circulate a gas within the autoclave along the spaces between the panels and adjacent walls of the autoclave shell and back along the autoclave shell between panels, with gas also being diverted from the spaces between the panels and adjacent walls of the autoclave shell into the autoclave shell between panels in an amount dependent on the extent of opening of the respective duct valves.

11. The autoclave of claim 1 further comprised of a computer control coupled to the duct valve actuators and coupleable to temperature sensors distributed within the autoclave, the computer being configured to control the duct valve actuators to obtain a desired temperature distribution within the autoclave responsive to the temperature sensors.

12. The autoclave of claim 11 wherein the temperature sensors are thermocouples disposed on at least work piece in the autoclave.

13. An autoclave comprising:
a cylindrical autoclave shell having a horizontal axis, a first closed end and a second openable end;
at least one fan motor with fan attached coupled to the closed end;
a roof panel within and spaced from a top surface of the autoclave shell;
the roof panel having a plurality of adjustable duct valves disposed along the roof panel for controllably diverting gas flowing between the roof panel and the top of the autoclave shell to the region below the roof panel.

14. The autoclave of claim 13 wherein the adjustable duct valves are independently controllable.

15. The autoclave of claim 13 wherein the adjustable duct valves are coupled together in groups, each group being controllable in unison.

16. The autoclave of claim 13 further comprising a floor panel parallel to the roof panel and spaced from a bottom wall of the autoclave shell.

17. The autoclave of claim 16 wherein the floor panel also has a plurality of adjustable duct valves disposed along the floor panel for controllably diverting gas flowing between the floor panel and the bottom wall of the autoclave shell to the space between the floor and roof panels.

18. The autoclave of claim 17 wherein the second panel is stepped downward between two sides thereof.

19. The autoclave of claim 17 further comprising first and second oppositely disposed side panels, each having a plurality of adjustable duct valves disposed along the respective side panel for controllably diverting gas flowing between the respective side panel and an adjacent side wall of the autoclave shell to the space between the floor and roof panels.

20. The autoclave of claim 19 wherein the floor panel is stepped downward between two sides thereof.

21. The autoclave of claim 19 wherein the fan is configured to circulate a gas within the autoclave along the spaces between the panels and adjacent walls of the autoclave shell and back along the autoclave shell between panels, with gas also being diverted from the spaces between the panels and adjacent walls of the autoclave shell into the autoclave shell between panels in an amount dependent on the extent of opening of the respective duct valves.

22. The autoclave of claim 13 further comprised of a computer control coupled to the duct valve actuators and coupleable to sensors distributed within the autoclave, the computer being configured to control the duct valve actuators to obtain a desired environmental distribution within the autoclave responsive to the sensors.

23. The autoclave of claim 22 wherein the sensors include temperature sensors.

24. The autoclave of claim 23 wherein the temperature sensors are thermocouples disposed on at least work piece in the autoclave.
